(19) United States
(12) Patent Application Publication
(10) Pub. No.: US 2026/0238054 A1
(43) Pub. Date: Aug. 13, 2026

(54) ROTOR AND METHOD FOR PRODUCING THE ROTOR

(71) Applicant: ZF Friedrichshafen AG, Friedrichshafen (DE)

(72) Inventors: Matthias WESA, Ravensburg (DE); Philipp NEIDHARDT, Markdorf (DE); David WÖRZLER, Langenargen (DE); Ignacio LOBO CASANOVA, Markdorf (DE)

(73) Assignee: ZF Friedrichshafen AG, Friedrichshafen (DE)

(21) Appl. No.: 19/156,525

(22) PCT Filed: Feb. 22, 2024
(86) PCT No.: PCT/EP2024/054544

§ 371 Date: Aug. 14, 2025

(30) Foreign Application Priority Data
Feb. 24, 2023 (DE) 10 2023 201 703.2

(51) Int. Cl. H02K 1/30; H02K 1/276; H02K 15/028; H02K 15/035

(52) U.S. Cl. CPC H02K 1/30; H02K 1/276; H02K 15/028; H02K 15/035

(57) ABSTRACT

A rotor for an electric machine, with rotor shaft, with plurality of rotor poles distributed in circumferential direction with magnet unit, with lamination stack which has a lamination core and insert segment for each rotor pole. The lamination core has a central shaft receptacle for receiving the rotor shaft and, for each rotor pole, a radially outwardly open segment receptacle for receiving the magnet units and the insert segments, and with a wrap surrounding the lamination stack which the magnet units and the insert segments are in the respective segment receptacle. The shaft receptacle has a plurality of supporting surfaces distributed in circumferential direction, and the rotor shaft has a plurality of mating surfaces (22) distributed in circumferential direction, and a supporting surface is supported in each instance at a mating surface of rotor shaft in radial direction with reference to rotational axis of rotor.

### PRIORITY CLAIM

This is a U.S. national stage of application No. PCT/EP2024/054544, filed on 22 Feb. 2024. Priority is claimed on German Application No. 10 2023 201 703.2 filed, 24 Feb. 2023, the content of which is incorporated here by reference.

### BACKGROUND OF THE INVENTION

Rotors for electric machines which typically have a rotor core formed of a plurality of stacked individual laminations are known. The rotor core has a plurality of magnet pockets distributed in circumferential direction for receiving permanent magnets. Generally, so-called buried permanent magnets which are embedded inside of the rotor core are employed for rotors of permanently excited synchronous machines (PSMs). Further, it is known to supplement the buried permanent magnets with surface magnets to improve efficiency, these surface magnets being arranged outside of the rotor core and fixed by a wrapping of the rotor core. A particularly high mechanical strength and rotational speed stability is achieved by wrapping the rotor core.

DE 10 2019 117 686 A1 discloses a rotor device for an electric machine with a rotor comprising a rotor core, a wrap which radially surrounds the rotor core, and a plurality of rotor poles. The rotor poles comprise in each instance at least two magnet units, namely, internal magnet units, which are buried in the rotor core and at least one magnet unit, namely, surface magnet units, arranged between the rotor core and the wrap.

### SUMMARY OF THE INVENTION

It is the object of the invention to provide a rotor of the type mentioned above which is characterized by a low weight and a simplified assembly.

An object of the invention is a rotor which is formed and/or suitable for an electric machine. In particular, the electric machine is formed and/or suitable for an electric axle drive and/or for driving a motor vehicle. The electric machine is preferably formed as an inrunner in which the rotor is arranged radially inside of a stator. For example, the electric machine may be formed as a traction machine, also known as a separate motor generator (SMG). Particularly preferably, the electric machine is formed as a permanently excited synchronous machine or PSM for short. The rotor has a rotor shaft. The rotor shaft may comprise one or more parts.

In particular, the rotor shaft essentially has a shaft portion for receiving a lamination stack and a first bearing portion and second bearing portion for receiving a rotor bearing. In principle, the shaft portion and the two bearing portions may be formed as separate components which are connected to one another, at least in circumferential direction, by positive engagement and/or frictional engagement and/or bonding engagement. Alternatively, the shaft portion and the two bearing portions can also be produced, particularly in one piece, from a common material portion. In particular, the axis of the rotor shaft defines a rotational axis of the rotor.

The rotor has a plurality of rotor poles which are distributed in circumferential direction and have at least one, or exactly one, magnet unit. The magnet units each preferably comprise one or more pole-generating magnets, particularly permanent magnets. The rotor preferably has more than four, preferably more than six, particularly more than eight, rotor poles which are uniformly distributed in circumferential direction. In particular, the rotor has 1n, 2n, 3n, 4n or 5n magnet units, where n corresponds to the quantity of rotor poles.

The rotor has at least one, or exactly one, lamination stack. In principle, the rotor can have exactly one lamination stack. Alternatively, the rotor may also be constructed of at least two partial lamination stacks which are arranged together on the rotor shaft successively in axial direction with reference to the rotational axis of the rotor and/or so as to be fixed with respect to rotation relative to one another. For example, the rotor can comprise more than two, preferably more than four, in particular more than six, partial lamination stacks.

The lamination stack basically has a lamination core and at least one, or exactly one, insert segment for each rotor pole. In a particularly preferred manner, the lamination stack is formed by a plurality of individual laminations stacked in axial direction with reference to the rotational axis of the rotor, and the insert segments are formed by a plurality of individual lamination segments stacked in axial direction with reference to the rotational axis of the rotor. The individual laminations and individual lamination segments are preferably formed in each instance from a magnetized and/or magnetizable material, preferably a steel alloy. In particular, the individual laminations and the individual lamination segments are formed as electrical steel laminations. The lamination stack is preferably formed circumferentially closed, in particular substantially annularly. Alternatively, the lamination core can also be formed so to be circumferentially segmented. For example, the segmentation can be carried out in circumferential direction in the region of the pole edges or at the pole edges. The insert segments are preferably formed separate from the lamination core or as separate components. Preferably, exactly one insert segment is associated with each rotor pole.

The lamination core has a central shaft receptacle which is formed and/or suitable for receiving the rotor shaft so as to be fixed with respect to relative to it. In particular, the central shaft receptacle penetrates the lamination core continuously and/or in a straight line in axial direction. The central shaft receptacle is preferably formed as a central through-opening or a central passage through which the rotor shaft is guided coaxially with reference to the rotational axis of the rotor. In particular, the shaft receptacles of the lamination cores of all of the partial lamination stacks are aligned in register with one another in circumferential direction and flush with one another in axial direction.

Further, for each rotor pole, the lamination core has a radially outwardly open segment receptacle which is formed and/or suitable for receiving at least one of the magnet units and at least one of the insert segments. In particular, the segment receptacles have a contour which complements and/or is geometrically similar to the insert segments. The insert segments are preferably supported in a positively engaging manner at the magnet units inside of the segment receptacles in circumferential direction and/or in radial direction with reference to the rotational axis of the rotor. The insert segments are preferably supported to fit snugly and/or free of play at the magnet units. In particular, the insert segments are received in the segment receptacles such that they define with their radial outer side an outer circumference of the rotor and/or are arranged on a common pitch circle around the rotational axis of the rotor.

The rotor has a wrap surrounding the lamination stack by means of which the magnet units and the insert segments are held in the respective segment receptacle. In particular, the magnet units and the insert segments are clamped between the lamination core and the wrap. The wrap is preferably formed by a fiber wrapping which can preferably be produced from carbon fibers or other fibrous materials, for example, metal fibers or a fiber composite, for example, fiber-reinforced plastic. In particular, the wrap can be formed from or comprise a thermoset or thermoplastic.

It is provided within the framework of the invention that the shaft receptacle has a plurality of supporting surfaces distributed in circumferential direction and that the rotor shaft has a plurality of mating surfaces distributed in circumferential direction, a supporting surface being supported in each instance at a mating surface of the rotor shaft in radial direction with reference to the rotational axis of the rotor. In particular, the supporting surfaces and mating surfaces are formed in each instance by planar surface portions which preferably extend in axial direction with reference to the rotational axis of the rotor and which, at least in radial direction, are supported and/or supportable against one another in a planar manner, in particular over the entire surface. In principle, the shaft receptacle and the rotor shaft can be connected to one another via a polygonal connection, the supporting surfaces and mating surfaces being formed as polygonal surfaces. The shaft receptacle can have at least two, or exactly two, of the supporting surfaces, these supporting surfaces being arranged opposite one another. However, it is particularly preferable that the shaft receptacle has more than two, particularly at least three, of the supporting surfaces, these supporting surfaces being spaced apart uniformly in circumferential direction. In a particularly preferable manner, the rotor shaft has the same quantity of mating surfaces as the shaft receptacle has supporting surfaces. In particular, the shaft receptacle and the rotor shaft each have a supporting surface and a mating surface, respectively, for each rotor pole.

The advantage of the invention consists in that a connection to the rotor shaft that is particularly fixed with respect to relative rotation and positively-engaging is produced by supporting the lamination stack via the supporting surfaces, and forces acting on the connection points are distributed over a large area on the rotor shaft via the supporting surfaces. In this way, the area pressure between the lamination stack and rotor shaft can be reduced and, further, the stiffness of the lamination stack can be increased. Accordingly, the lamination stack can be produced with a particularly small overall radial height so that the total weight of the rotor and the cost of producing the lamination stack can be appreciably reduced. Further, a rotor is proposed that is characterized by low drag torques and, therefore, an improved operating behavior.

In a particular embodiment, it is provided that the rotor shaft has a shaft portion which is formed as a half-shaft, the mating surfaces being formed, respectively, by a cylinder frustum extending parallel to the rotational axis of the rotor. In particular, the mating surfaces are uniformly spaced apart from one another in circumferential direction, two adjacent cylinder frustums in each instance being connected to one another via a radius. The cylinder frustums preferably extend in circumferential direction over more than 5%, preferably more than 8%, of the circumferential surface. Alternatively or optionally additionally, the cylinder frustums extend in circumferential direction in an angular range of more than 15°, preferably more than 25°, in each instance. In a particularly preferred manner, the supporting surfaces and the mating surfaces have the same width or at least approximately the same width, at least in circumferential direction or in tangential direction. An advantage consists in that, as a result of the cylinder frustums, a rotor shaft is proposed which is producible in a simple manner, for example, by forming. Also, as a result of the hollow shaft configuration, a rotor is proposed that is characterized by a particularly low weight and low inertias.

In another particular implementation, it is provided that the shaft receptacle and the rotor shaft have an n-fold rotational symmetry with reference to the rotational axis of the rotor, where n corresponds to the quantity of rotor poles. In other words, the shaft receptacle or rotor shaft, respectively, can be mapped onto itself by rotating through an angle of 360°/n. For example, if the rotor has n=6 rotor poles, the shaft receptacle and the rotor shaft have a six-fold rotational symmetry. Simply put, with a six-pole rotor, the supporting surfaces and the mating surfaces are arranged with a spacing, particularly a center spacing, of 60° around the axis of rotation. Accordingly, the rotational symmetry makes possible a symmetrical construction of the lamination core and rotor shaft, respectively, so that the mounting of the lamination core at the rotor shaft can be realized in a particularly simple and cost-effective manner.

In a further specific embodiment, it is provided that an outer radius of the rotor shaft is greater than 60% of the total radius of the rotor. In particular, the outer radius of the rotor shaft is between 60% and 80% of the total radius of the rotor. Therefore, by configuring the rotor shaft as a hollow shaft, a rotor may be proposed that is characterized by a small overall axial height of the lamination core and, at the same time, by a low weight.

In a further development, it is provided that a maximum of, or exactly, three of the supporting surfaces are formed as contact surfaces, these contact surfaces being supported free from play at the respective associated mating surface, particularly in radial direction with reference to the rotational axis of the rotor. In particular, the contact surfaces serve for centering and/or for transmission of torque between the lamination core and the rotor shaft. The contact surfaces are preferably supported at the respective associated mating surface in a positively engaging and/or frictionally engaging manner in radial direction with reference to the rotational axis of the rotor. Accordingly, by configuring the maximum of three supporting surfaces as contact surfaces, an overdetermination of the areas contacting one another is prevented during assembly of the lamination stack, which further simplifies assembly.

In one embodiment, it is provided that the contact surfaces are supported at the respective mating surface via an interference fit. In particular, the lamination stack can be pressed onto the rotor shaft in axial direction with reference to the rotational axis of the rotor in order to produce the interference fit. The lamination stack is preferably fixed in a frictionally engaging manner on the rotor shaft by the interference fit in axial direction with reference to the rotational axis of the rotor. Particularly preferably, the tolerance range of the interference fit is selected so as to result in an interference fit which may be manually overcome and/or produced. Accordingly, a rotor is proposed that is characterized by a particularly secure mounting of the lamination stack at the rotor shaft.

In a further implementation, it is provided that the interference fit is produced by interference at the respective mating surfaces. In other words, all of the supporting surfaces have the same radial distance from the rotational axis of the rotor and/or all of the supporting surfaces touch a common pitch circle with reference to the rotational axis of the rotor. On the other hand, the mating surfaces contacting the contact surfaces have a larger radial distance from the rotational axis of the rotor than the rest of the mating surfaces and/or the mating surfaces contacting the contact surfaces touch a pitch circle with greater radius than the rest of the mating surfaces.

Alternatively, the interference fit is produced by an interference at the respective supporting surfaces. In other words, all of the mating surfaces have the same radial distance from the rotational axis of the rotor and/or all of the mating surfaces touch a common pitch with reference to the rotational axis of the rotor. On the other hand, the contact surfaces have a smaller radial distance from the rotational axis of the rotor than the rest of the supporting surfaces and/or the contact surfaces touch a pitch circle with a smaller radius than the rest of the supporting surfaces.

In a further development, it is provided that all of the further supporting surfaces are formed as auxiliary surfaces, these auxiliary surfaces being supported and/or supportable, at least during an assembly of the lamination core, particularly in radial direction with reference to the rotational axis of the rotor, with the respective associated mating surface so as to have play. In particular, the auxiliary surfaces serve to additionally support the lamination core during transmission of high torque and/or a high loading or deformation of the lamination core. In particular, “so as to have play” means that the auxiliary surfaces are arranged with close tolerances and no overlapping relative to the mating surfaces. The auxiliary surfaces are preferably supported and/or supportable in radial direction with reference to the rotational axis of the rotor at least in a positively engaging manner at the respective associated mating surface. The rotor preferably has six rotor poles. Three of the supporting surfaces are formed as contact surfaces and three of the supporting surfaces are formed as auxiliary surfaces. The contact surfaces and the auxiliary surfaces are preferably arranged to alternate in circumferential direction. Accordingly, by configuring the rest of the supporting surfaces as auxiliary surfaces, a stable support of the lamination core at the rotor shaft is achieved, as a result of which the stiffness of the rotor, particularly of the lamination stack, is further improved.

In a further embodiment, it is provided that the auxiliary surfaces are supported and/or supportable at the respective mating surface via a clearance fit. In particular, a slight radial play of less than 50 μm, preferably less than 20 μm, particularly less than 5 μm, is formed between the mating surface and the auxiliary surface at least in the assembly state. Accordingly, a radial clearance is proposed that is closed in a simple manner during loading of the lamination core and therefore allows the auxiliary surfaces to abut the mating surfaces.

In a further specific implementation, it is provided that a radial force is applied to the lamination stack through the wrap and, owing to a deformation of the lamination stack resulting from the radial force, the auxiliary surfaces are supported without play at the respective associated mating surface. In other words, the lamination core is deformed in radial direction when wrapped with the wrap such that the auxiliary surfaces contact the mating surfaces and the radial clearance between the auxiliary surface and the respective mating surface is reduced or closed. Accordingly, a rotor is proposed that is characterized by a particularly stable contact of the lamination core at the rotor shaft in the final assembly state.

In another particular embodiment, it is provided that the lamination core has a plurality of through-openings which are distributed and/or spaced apart in circumferential direction and are formed and/or suitable for forming a cooling channel and/or for reducing weight. The through-openings are formed in circumferential direction between the supporting surfaces. In particular, the through-openings pass through the lamination stack in axial direction continuously and/or in a straight line. A flow path along which the coolant flows through the rotor in axial direction with reference to the rotational axis of the rotor and dissipates heat is preferably defined by the through-openings formed as cooling channels. In particular, the rotor lamination stack has in each instance one cooling channel per rotor pole. In principle, the through-openings can be formed by bore holes, passages or the like which are introduced axially into the lamination core or individual laminations and form a passage in axial direction which is formed closed in the lamination core. However, the through-openings are preferably formed by cutouts, passages or the like which are introduced radially in the lamination core or individual laminations and which form a passage in axial direction which is open at the inner circumference. The through-openings are preferably limited in radial direction by an outer circumference of the rotor shaft. Accordingly, a lamination core can be produced that is characterized by a particularly low weight.

In a particular embodiment, it is provided that the rotor poles in each instance have exactly two inner magnet units and exactly two outer magnet units, both inner magnet units and both outer magnet units being formed in a V-shape relative to one another. By “inner magnet units” is meant, in particular, radially inner magnet units, particularly buried magnet units, whereas by “outer magnet units” is meant radially outer magnet units. In particular, the V-shaped arrangement of the inner magnet unit and outer magnet unit opens outwardly in radial direction with reference to the rotational axis of the rotor. The two inner magnet units and the two outer magnet units of a rotor pole, respectively, are preferably arranged angularly, particularly equiangularly, with respect to the radius of the rotor. Alternatively, the two inner magnet units and the two outer magnet units may also be arranged at different angles with respect to the radius of the rotor. Simply put, the inner magnet units and the outer magnet units are arranged in a V-shaped or W-shaped arrangement in two layers. By means of the V-shaped arrangement of the inner magnet units and outer magnet units, the rotor can be optimized in a simple manner with respect to its drag torques.

In particular, it is provided that the lamination core has, for each rotor pole, an inner magnet receptacle for receiving the inner magnet units and an outer magnet receptacle for receiving the outer magnet units. In particular, the inner magnet receptacle is formed radially between the lamination core and the insert segment. In particular, the outer magnet receptacle is formed radially between the insert segment and a further insert segment. The magnet receptacle preferably serves to receive the magnet units in a positively engaging and/or frictionally engaging manner. To this end, the lamination core and/or the insert segment has, for each magnet unit, a holding structure which fixes the respective magnet unit in a positively engaging and/or frictionally engaging manner. The holding structure is preferably formed integral with the lamination core or insert segment, respectively, and is formed in particular from a common material portion. For example, the holding structure is formed as a holding protuberance or narrowing or projection or the like. Alternatively, the holding structure may also be formed by a recess formed at the lamination core and/or insert segment. In particular, it can be provided that the outer magnet units and/or the inner magnet units of two adjacent partial lamination stacks are arranged to be offset by a cant angle in circumferential direction.

In a further configuration, it is provided that the rotor has a first end disk and a second end disk which are arranged at the ends at respective axial end sides of the lamination stack. The two end disks each have a shaft receptacle complementing the rotor shaft. In particular, the shaft receptacle of the end disks has a plurality of supporting surfaces which are distributed in circumferential direction and are supported in radial direction with reference to the rotational axis of the rotor at a corresponding mating surface of the rotor shaft, particularly of the shaft portion. The maximum of three of the supporting surfaces are preferably constructed as contact surfaces. Particularly preferably, the shaft receptacles of the end disks have an n-fold rotational symmetry. In particular, the end disks are formed as balancing disks. In particular, the end disks are arranged at the shaft portion and/or one of the bearing portions so as to be fixed with respect to rotation relative to it via the shaft receptacle. This makes it possible to mount the end disks at the rotor shaft in a particularly simple manner.

In a further implementation, it is provided that the rotor has central securing means which are formed and/or suitable to axially secure the lamination stack. To this end, the lamination stack and the two end disks are secured or clamped between an axial end stop of the rotor shaft and of the securing means in axial direction with reference to the rotational axis of the rotor. In particular, an axial compressive force can be applied to the end disks and, therefore, to the lamination stack via the securing means in that the securing means are mounted on, preferably screwed to, the rotor shaft and tightened with a tightening torque. As a result, a press fit is provided for the lamination stack between the two end disks. The rotor shaft, particularly one of the bearing portions, preferably has the axial end stop. The end stop may be formed as a circumferential collar, step, annular shoulder or the like. The securing means are preferably formed as a shaft nut. To this end, the rotor shaft, particularly the other bearing portion, preferably has an external thread via which the shaft nut engages. Alternatively, the securing means may also be formed as a press ring. Accordingly, a rotor is proposed in which the lamination stack can be fixed and secured to the rotor shaft in a simple and economical manner.

A further object of the invention relates to a method for producing a rotor according to one of the preceding claims in which the rotor shaft is provided; the lamination core is connected to the rotor shaft via the shaft receptacle in a positively engaging manner, particularly so as to be fixed with respect to rotation relative to it, and the lamination core is radially supported at the mating surfaces of the rotor shaft via the supporting surfaces of the shaft receptacle; the magnet units and the insert segments are inserted into the segment receptacles; the wrap is wound around the lamination stack.

In particular, it is provided that the lamination stack is produced in a manufacturing process, e.g., by means of in-die stacking, and subsequently mounted on the rotor shaft in axial direction with reference to the rotational axis of the rotor in accordance with the previously described method. Alternatively or optionally additionally, the individual laminations can also be bondingly connected to one another, for example, by means of backlack or dotted glue. The assembly of the rotor can preferably be carried out manually. Alternatively, one or more of the assembly steps may be automated or partially automated.

In a first assembly step, the first end disk is preferably mounted at the prepared rotor shaft, particularly at the first bearing portion and/or shaft portion. To this end, the first end disk is slid onto the rotor shaft via the shaft receptacle until the first end disk contacts the axial end stop. An alignment of the end disk is preferably carried out via the geometry of the rotor shaft or first bearing portion and/or shaft portion. In particular, the first end disks can be connected to the mating surfaces in a force-fitting or frictionally engaging manner via the contact surfaces of the shaft receptacle in order to protect against loss of the first end disk.

In a second assembly step, the laminated core is preferably mounted at the prepared rotor shaft, in particular at the shaft portion. To this end, the lamination core is slid onto the shaft portion via the shaft receptacle until the lamination core contacts the first end disk. An alignment of the end disk is preferably carried out via the geometry of the rotor shaft or shaft portion. In particular, the lamination core can be connected to the mating surfaces in a force-fitting or frictionally engaging manner via the contact surfaces of the shaft receptacle in order to protect against loss of the lamination core.

In a third assembly step, a filling body can be inserted in each instance into the through-openings of the lamination core to form the cooling channels. To this end, the filling bodies are inserted into the respective associated through-opening in axial direction with reference to the rotational axis of the rotor until the filling bodies contact the first end disk. An alignment of the filling bodies is preferably carried out via the geometry of the rotor shaft or shaft portion.

In a fourth assembly step, the second end disk is preferably mounted at the prepared rotor shaft, particularly at the second bearing portion and/or shaft portion. To this end, the second end disk is pushed onto the rotor shaft via the shaft receptacle until the second end disk contacts the lamination core. An alignment of the second end disk is preferably carried out via the geometry of the rotor shaft or second bearing portion and/or the shaft portion. In particular, the second end disk can be connected to the mating surfaces in a force-fitting or frictionally engaging manner via the contact surfaces of the shaft receptacle in order to prevent loss of the second end disk. Alternatively, all of the magnet units and all of the insertion elements may also first be mounted in the segment receptacle, as will be described in the following, and the second end disk mounted only subsequently.

In a fifth assembly step, the securing means are pre-mounted at the prepared rotor shaft, particularly at the second bearing portion. To this end, the securing means are screwed onto the second bearing portion until the securing means and, therefore, the second end disk are protected against loss.

In a further assembly step, the magnet unit and the insert segments can be inserted into the respective segment receptacle. To this end, the magnet units and the insert segments can be mounted pole by pole. For example, the mounted magnet units and the insert segments can be captively held in the respective associated segment receptacle via an assembly device. It is preferably provided that the magnet units and the insert segments of a rotor pole are inserted into the associated segment receptacle and subsequently secured by means of the assembly device. For example, the assembly device can serve as transport safety. The securing means can preferably apply a predefined mounting force after all of the magnet units and insert segments have been mounted in order to apply a compressive force to the laminated core, the magnet units and the insert segments between the two end disks and to fix them free from play.

In a final assembly step, the wrap is wound around the lamination stack. The lamination stack is preferably wrapped with a wrapping thread comprising in particular one or more filaments, particularly a wrapping thread of carbon fiber. To this end, the leading end of a thread can be fixed to the assembly device and the wrapping thread can subsequently be wrapped around the outer circumference of the lamination stack in one or more layers. In so doing, the wrapping thread is wound around the lamination stack with a defined pre-tensioning and, therefore, the radial force or a pressing force is applied to the lamination stack, particularly the lamination core, as a result of which the latter contacts the mating surfaces with the auxiliary surfaces.

### BRIEF DESCRIPTION OF THE DRAWINGS

Further features, advantages and effects of the invention will become apparent from the following description of preferred exemplary embodiments of the invention. The drawings show:

FIG. 1 an axial view of a rotor for an electric machine as an exemplary embodiment of the invention;

FIG. 2 a detail view of the rotor from FIG. 1;

FIG. 3 an axial view of a rotor shaft of the rotor from FIG. 1;

FIG. 4 a sectional view of the rotor from FIG. 1 along a rotational axis of the rotor;

FIG. 5 a perspective view of an end disk of the rotor from FIG. 1;

FIG. 6 an axial view of an alternative construction of the rotor.

### DETAILED DESCRIPTION OF THE DISCLOSED EMBODIMENTS

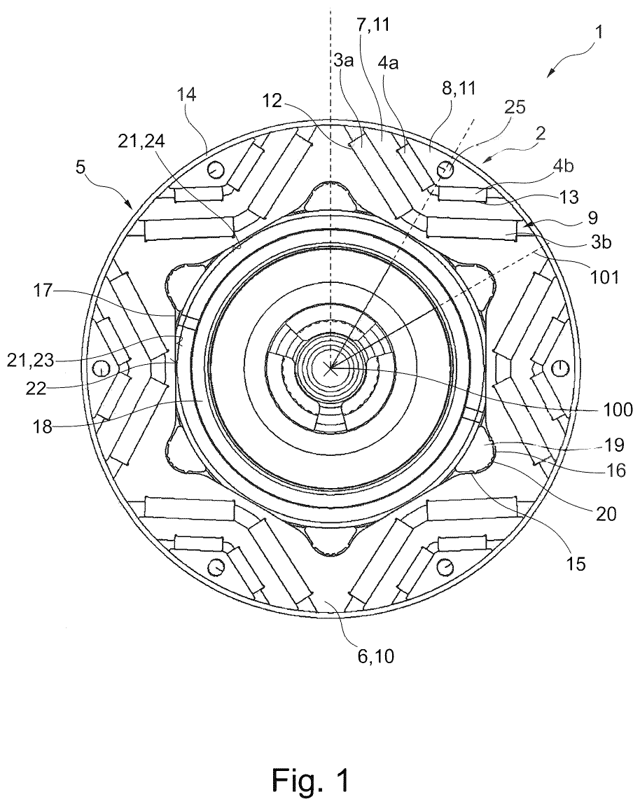

FIG. 1 shows a rotor 1 in an axial view with reference to a rotational axis 100 of the rotor 1 which is formed and/or suitable for an electric machine, not shown, of an electric vehicle. The electric machine is a permanently excited synchronous machine.

In the depicted embodiment example, the rotor 1 comprises six rotor poles 2 uniformly distributed in circumferential direction around the rotational axis 100 of the rotor 1. Each rotor pole 2 has two inner magnet units 3a, 3b and two outer magnet units 4a, 4b. The inner magnet units 3a, 3b and the outer magnet units 4a, 4b are formed, respectively, by at least one pole-generating magnet which is formed, for example, as a rod-shaped permanent magnet. In the depicted embodiment example, the inner magnet units 3a, 3b and the outer magnet units 4a, 4b are arranged in a V-shaped manner, respectively. The inner magnet units 3a, 3b are located radially inward and the outer magnet units 4a, 4b are located radially outward.

The rotor 1 comprises at least one lamination stack 5 which is substantially formed from a star-shaped lamination core 6 and, one each per rotor pole 2, an insert segment 7 and a further insert segment 8. The insert segments 7, 8 of each rotor pole 2 are received, respectively, in a positively engaging manner in a segment receptacle 9 formed at the lamination core 6. The lamination core 6 is formed by a plurality of individual laminations 10 stacked one on top of the other in axial direction with reference to the rotational axis 100 of the rotor 1, and the insert segments 7 and further insert segment 8 are formed by a plurality of individual laminations segments 11 stacked one on top of the other in axial direction with reference to the rotational axis 100 of the rotor 1. For example, the individual laminations 10 and the individual lamination segments 11 can be produced and connected to one another by in-die stacking.

An inner magnet receptacle 12 which serves to receive the two inner magnet units 3a, 3b is formed between the lamination core 6 and the insert segment 7 in each instance. Further, an outer magnet receptacle 13 which serves to receive the two outer magnet units 4a, 4b is formed in each instance between the insert segment 7 and the further insert segment 8. For example, the magnet units 3a, 3b, 4a, 4b are captively held in the respective magnet receptacle 12, 13, e.g., by positive engagement and/or frictional engagement. To this end, the lamination core 6 and the insert segment 7 can have a corresponding recess, holding structure or the like. In the assembled state, the insert segment 7 is supported in radial direction and in circumferential direction at the two inner magnet units 3a, 3b by positive engagement in order to form the inner magnet receptacle 12, and the further insert segment 8 is supported in radial direction and in circumferential direction by positive engagement at the two outer magnet units 4a, 4b to form the outer magnet receptacle 13.

Further, the rotor 1 has a wrap 14 which encircles the lamination stacks 5 at the outer circumference. The wrap 14 serves to hold the individual components of the rotor 1 together and to shield the rotor 1 from heat. In this regard, the inner magnet units 3a, 3b and outer magnet units 4a, 4b and the insert segments 7, 8 are captively held or clamped in the segment receptacles 9 between the lamination core 6 and the wrap 14. For example, the wrap 14 may be formed by a wrapping of carbon fibers.

The lamination core 6 has, for each rotor pole 2, respectively, a through-opening 15 which serves to form a cooling channel 16 and simultaneously reduce weight. The through-openings 15 are formed in each instance in circumferential direction between the magnet receptacles 3a, 3b, 4a, 4b of two adjacent poles 2 at an inner circumference of the lamination core 6 and lie, respectively, on a q-axis 101 which extends in radial direction and along which the pole edges of the rotor poles 2 extend. The through-openings 15 extend, respectively, parallel to the rotational axis 100 of the rotor 1.

Further, the lamination core 6 has a central shaft receptacle 17 via which the lamination stack 5 is arranged on a rotor shaft 18 so as to be fixed with respect to rotation relative to it. For this purpose, the rotor shaft 18 is guided through the shaft receptacle 17 coaxially with reference to the rotational axis 100 of the rotor 1. The shaft receptacles 17 pass through the lamination core 6 in axial direction with reference to the rotational axis 100 of the rotor 1.

The rotor 1 has a plurality of filling bodies 19 which are inserted in the through-openings 15 in axial direction with reference to the rotational axis 100 of the rotor 1 in order to form at least one cooling channel 16 between the lamination core 6 and the rotor shaft 17. To this end, the filling bodies 19 have at an outer side facing the lamination core 6 one or more spacing contours 20 via which the filling body 19 is supported in radial direction with reference to the rotational axis 100 of the rotor 1 so as to be spaced from the lamination core 3 with a slight clearance to form the cooling channel 16. At an inner side facing the rotor shaft 18, the filling bodies 19 are supported in radial direction in a positively engaging and/or frictionally engaging manner at an outer contour of the rotor shaft 18.

The lamination core 6 is connected to the rotor shaft 17 in a positively engaging and/or frictionally engaging manner via the shaft receptacle 17 in circumferential direction around the rotational axis 100 of the rotor 1. To this end, the rotor shaft 18 has one supporting surface 21 per rotor pole 2. The supporting surfaces 21 are supported in each instance at a mating surface 22 formed at the rotor shaft 18. The supporting surface 21 and the mating surface 22 are formed, respectively, as planar surface portions which contact one another at least in a positively engaging manner in radial direction with reference to the rotational axis 100 of the rotor 1. To avoid overdetermination, it is provided that three of the supporting surfaces 21 are formed as contact surfaces 23 and the rest of the supporting surfaces 21, in particular three supporting surfaces 21, are formed as auxiliary surfaces 24. The contact surfaces 23 and the auxiliary surfaces 24 are arranged to alternate in circumferential direction. In other words, the contact surfaces 23 are arranged in each instance to be offset in circumferential direction by 120° around the rotational axis 100 of the rotor 1. To form the contact surfaces 23, the respective supporting surfaces 21 are supported at the respective associated mating surface 22 via a press fit so that a centering of the lamination cores 6 is brought about via the contact surfaces 23 during assembly. To form the auxiliary surfaces 24, the respective supporting surfaces 21 are arranged at the respective associated mating surface 22 via a clearance fit, and the auxiliary surfaces 24 abut the respective mating surface 22 at least in a positively engaging manner when fitting the wrap 14.

The rotor 1 comprises, per rotor pole 2, at least one clamping means receptacle 24 for receiving clamping means which, for example, can be fitted for purposes of assembly in the clamping means receptacle 25. The clamping means receptacles 25 are formed in the depicted embodiment example in the further insert segments 8 and extend in each instance parallel to the rotational axis 100 of the rotor 1, the clamping means receptacles 25 of all of the partial lamination stacks 5a, 5b being arranged in register with and flush with one another.

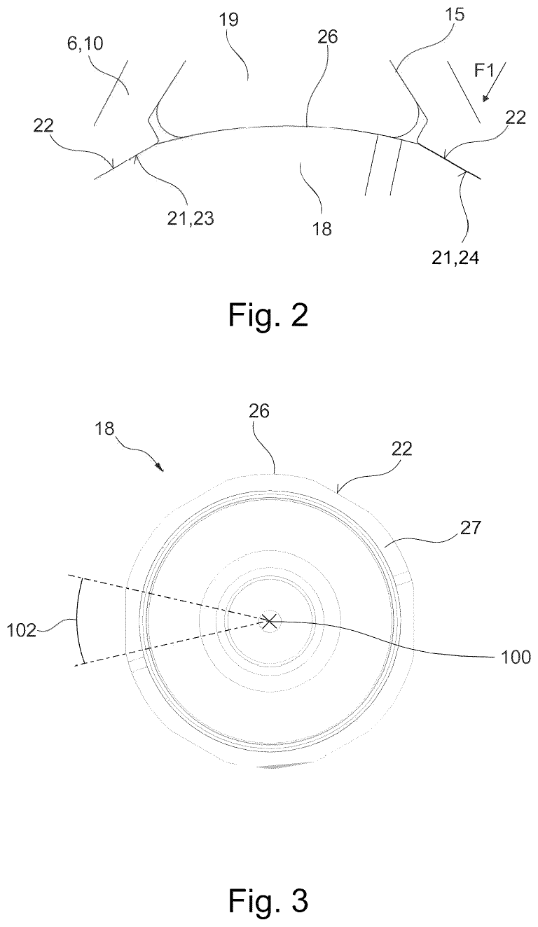

FIG. 2 shows the rotor 1 from FIG. 1 in a detail view. In order to form the interference fit, the mating surfaces 22 of the rotor shaft 18 which contact the contact surfaces 23 are produced with interference relative to the mating surfaces 22 of the rotor shaft 18 which contact the auxiliary surfaces 24. Accordingly, all of the supporting surfaces 21 formed at the lamination core 6 have the same radial distance from the rotational axis 100 of the rotor 1 or all touch a common pitch circle with reference to the rotational axis 100 of the rotor 1. Accordingly, during assembly, the supporting surfaces 21 which contact the mating surfaces 22 having the interference form the contact surfaces 24.

In an assembly state in which the wrap 14 has not yet been fitted, a slight radial play, for example, less than 10 μm, is formed between the auxiliary surfaces 24 and the mating surfaces 22. When the wrap 14 is fitted, particularly during a wrapping process, a radial force F1 is generated which acts radially on the lamination stack 6 in direction of the rotational axis 100 of the rotor 1. The radial force F1 results from a tightening force exerted on the wrap 14, particularly a wrap thread, during the wrapping process. As a result of the radial force F1, the lamination stack undergoes a deformation, particularly in radial direction with reference to the rotational axis 100 of the rotor 1, such that the auxiliary surfaces 24 contact the respective associated mating surface 22 without clearance.

The through-openings 15 are formed in circumferential direction, respectively, between two adjacent supporting surfaces 21 in the lamination core 6. The through-openings 15 may be formed in each instance by a cutout which is limited in radial direction by a radius 26 of the rotor shaft 18. For example, the filling bodies 19 directly contact the radius of the rotor shaft 18 in a positively engaging and/or frictionally engaging manner in radial direction with reference to the rotational axis 100 of the rotor 1.

As is shown in FIG. 3, the rotor shaft 18 has exactly six mating surfaces 22, these mating surfaces 20 being uniformly distributed so as to be spaced apart in circumferential direction. The rotor shaft 18 has a shaft portion 27 formed as a hollow shaft. The mating surfaces 22 are formed, respectively, by a cylinder frustum of the shaft portion 27 extending parallel to the rotational axis 100 of the rotor 1. The mating surfaces 22 and the radii 26 are arranged to alternate in circumferential direction resulting in an n-fold rotational symmetry, where n corresponds to the quantity of rotor poles 2. In the depicted embodiment example, the rotor shaft 18 or shaft portion 27 and, therefore, the shaft receptacle 17 have a six-fold rotational symmetry.

For example, the mating surfaces 22 extend in each instance, over more than 5% and/or less than 10% of the entire circumferential surface of the shaft portion 27. In other words, the mating surfaces 22 extend, respectively, in an angular range 102 of at least, or exactly, 30°. This makes possible a particularly stable support of the lamination core 6 at the shaft portion 27.

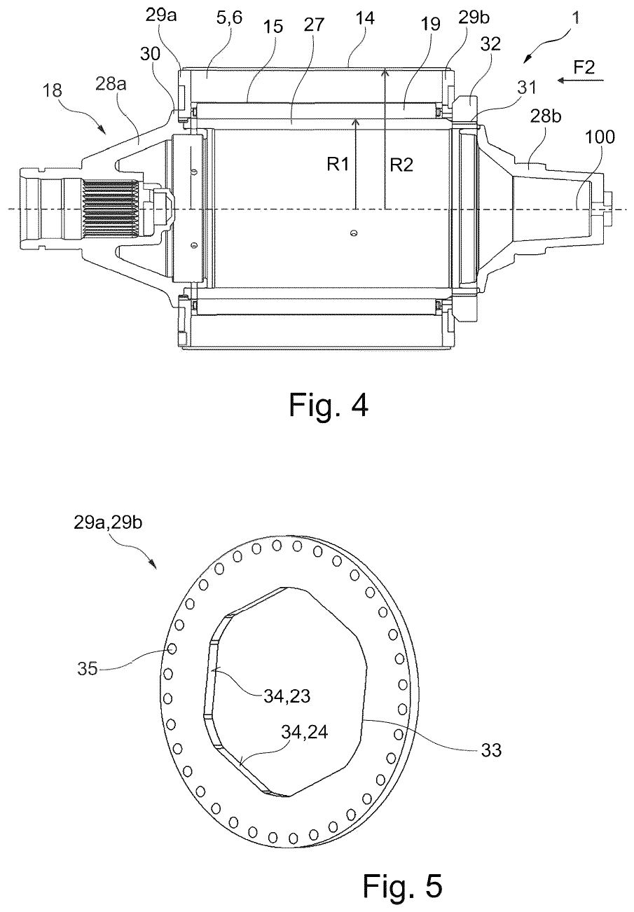

As is shown in FIG. 4, the rotor shaft 18 has a first bearing portion 28a and a second bearing portion 28b, these two bearing portions 28a, 28b and the shaft portion 27 being formed as separate component parts. The two bearing portions 28a, 28b can be connected to the shaft portion 27, for example, in a positively engaging and/or frictionally engaging manner, preferably so as to be fixed with respect to rotation relative to it. The two bearing portions 28a, 28b serve substantially for rotatably supporting the rotor shaft 18 in a housing of the electric machine. To this end, a rotor bearing, e.g., a rolling element bearing, can be fitted to the first bearing portion 28a and/or second bearing portion 28b.

The rotor 1 has a first end disk 29a and a second end disk 29b, these end disks 29a, 29b being arranged at the ends at an axial front side of the lamination stack 5 in each instance coaxial to the rotational axis 100 of the rotor 1. The two end disks 29a, 29b are constructed as balancing disks formed separately from the lamination stack 5 and the two bearing portions 28a, 28b. In this regard, the first end disk 29a is supported in a positively engaging manner at a first axial front side in axial direction between the first bearing portion 28a and the lamination stack 5 and is supported in a positively engaging manner, particularly so as to be fixed with respect to relative rotation, at the first bearing portion 28a and/or the shaft portion 27 in radial direction and in circumferential direction. The second end disk 29b is supported at a second axial front side in a positively engaging manner in axial direction between the second bearing portion 28b and the lamination stack 5 and is supported in radial direction and in circumferential direction in a positively engaging manner. particularly so as to be fixed with respect to relative rotation, at the second bearing portion 28b and/or at the shaft portion 27.

To this end, the first bearing portion 28a has at its outer circumference an axial end stop 30 which is formed circumferentially relative to the rotational axis 100 of the rotor 1. For example, the end stop 30 is formed by an annular shoulder surrounding the rotational axis 100 of the rotor 1. The end stop 30 serves to axially support the first end disk 29a at the first bearing portion 28a.

Further, the second bearing portion 28b has an external thread 31 via which securing means 32 can be fitted to or screwed onto the second bearing portion 29b. For example, the securing means 32 are formed by a shaft nut. The securing means 32 serve to apply an axial compressive force F2 to the second end disk 29b and, therefore, to the lamination stack 5 in order to produce an interference fit for the lamination stack 5 between the two end disks 29a, 29b.

As can be seen from FIG. 4, the shaft portion 27 has an outer radius R1 which amounts to more than 60% of the entire radius R2 of the rotor 1 and of the lamination stack 5. For example, the outer radius R1 of the shaft portion 27 is between 60% and 70% of the total radius R2. Accordingly, a rotor 1 is proposed which is characterized by a particularly small overall radial height of the lamination stack 5 and, therefore, by a particularly low weight.

FIG. 5 shows a perspective view of one of the two end disks 29a, 29b. For example, the two end disks 29a, 29b can be formed as carryover parts and may be produced from stainless steel. The end disks 29a, 29b have in each instance a central shaft receptacle 33 via which the end disks 29a, 29b are arranged on the rotor shaft 18, particularly the shaft portion 27 and/or the associated bearing portion 28a, 28b, so as to be fixed with respect to rotation relative to the latter. To this end, the shaft receptacle 33 has a plurality of supporting surfaces 34 which are distributed in circumferential direction and which cooperate, for example, with the mating surfaces 22 of the shaft portion 27. Three of the supporting surfaces 33 can be constructed as the contact surfaces 23 and three of the supporting surfaces 33 can be constructed as the auxiliary surfaces 24.

Further, the end disks 29a, 29b have a plurality of through-bores 35 which are introduced at the outer diameter of the end disks 29a, 29b so as to be uniformly distributed in circumferential direction. The through-bores 35 serve on the one hand to receive the clamping means, not shown. For this purpose, individual through-bores 35 are arranged, respectively, in register with one of the clamping means receptacles 25m as is shown in FIG. 1. Optionally, the through-bores 35 serve to receive balancing weights. To this end, for example, the balancing weights can be inserted into the through-bores 35 in a positively engaging and/or frictionally engaging manner.

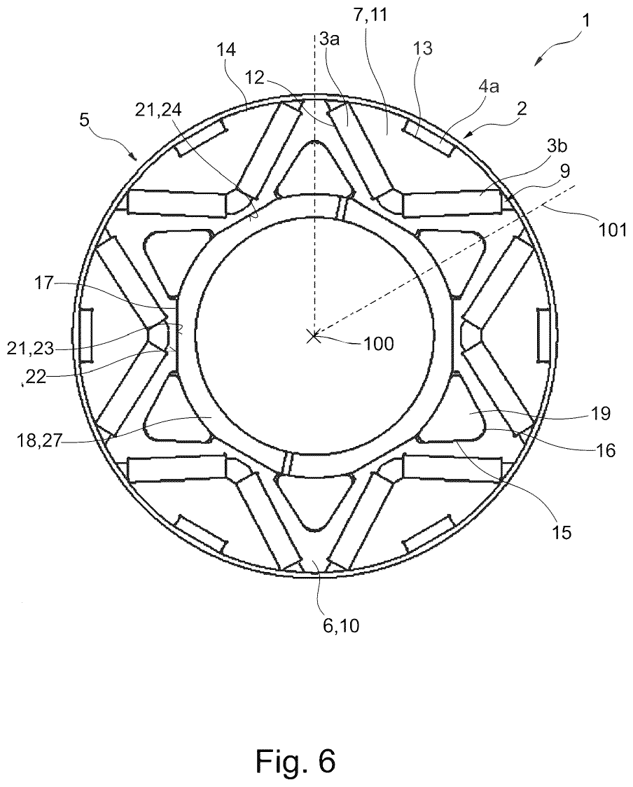

FIG. 6 shows an alternative construction of the rotor 1 which has, per rotor pole 2, only one outer magnet unit 4a rather than the two outer magnet units 4a, 4b. In the depicted embodiment example, the inner magnet units 3a, 3b are arranged in a V-shape, and the outer magnet unit 4a is arranged radially outwardly and tangentially aligned between the insert segment 7 and the wrap 14. The outer magnet unit 4a accordingly contacts the radial outer side of the insert segment 7 and the wrap 14. To this end, the insert segment 7 has at its outer side a recess as the outer magnet receptacle 13 in which the outer magnet unit 4a is inserted. In the assembled state, the insert segment 7 is supported at the two inner magnet units 3a, 3b in radial direction and in circumferential direction in a positively engaging manner to form the inner magnet receptacle 12. The outer magnet receptacle 13 is formed in radial direction between the insert segment 7 and the wrap 14.

1. A rotor for an electric machine, with a rotor shaft, with a plurality of rotor poles which are distributed in circumferential direction and have at least one magnet unit, with at least one lamination stack which has a lamination core and at least one insert segment for each rotor pole wherein the lamination core has a central shaft receptacle for receiving the rotor shaft so as to be fixed with respect to relative to it and, for each rotor pole, a radially outwardly open segment receptacle for receiving at least one of the magnet units and at least one of the insert segments, with a wrap which surrounds the lamination stack and via which the magnet units and the insert segments are held in the respective segment receptacle, wherein the shaft receptacle has a plurality of supporting surfaces distributed in circumferential direction, and the rotor shaft has a plurality of mating surfaces distributed in circumferential direction, wherein a supporting surface is supported in each instance at a mating surface of the rotor shaft in radial direction with reference to the rotational axis of the rotor.

2. The rotor according to claim 1 further comprising a shaft portion which is formed as a half-shaft, wherein the mating surfaces are formed, respectively, by a cylinder frustum of the shaft portion extending parallel to the rotational axis of the rotor.

3. The rotor according to claim 1, wherein the shaft receptacle and the rotor shaft have an n-fold rotational symmetry, where n corresponds to the quantity of rotor poles.

4. The rotor according to claim 1, wherein an outer radius (R1) of the rotor shaft amounts to more than 60% of the total radius (R2) of the rotor.

5. The rotor according to claim 1, wherein a maximum of three supporting surfaces are formed as contact surfaces, these contact surfaces being supported without play at the respective associated mating surface-.

6. The rotor according to claim 5, wherein the contact surfaces are supported at the respective mating surface via an interference fit.

7. The rotor according to claim 6, wherein the interference fit is produced by interference, electively, at the respective mating surfaces or at the respective supporting surfaces.

8. The rotor according to claim 5, wherein all of the further supporting surfaces are formed as auxiliary surfaces which are supported, at least during an assembly of the lamination core, at the respective associated mating surface so as to have play.

9. The rotor according to claim 8, wherein the auxiliary surfaces are supported at the respective mating surface via a clearance fit.

10. The rotor according to claim 8, wherein a radial force (F1) is applied to the lamination stack through the wrap so that the auxiliary surfaces are supported free from play at the respective associated mating surface owing to a deformation of the lamination core.

11. The rotor according to claim 1, wherein the lamination core has a plurality of through-openings distributed in circumferential direction for forming a cooling channel and/or for reducing weight, wherein the through-openings are formed in circumferential direction between the supporting surfaces.

12. The rotor according to claim 1, wherein the rotor poles in each instance have exactly two inner magnet units and exactly two outer magnet units, wherein, in each instance, both inner magnet units and both outer magnet units are formed in a V-shape relative to one another.

13. The rotor according to claim 1, wherein a first end disk and a second end disk which are arranged at the ends at respective axial front sides of the lamination stack, wherein the two end disks each have a shaft receptacle complementing the rotor shaft.

14. The rotor according to claim 13, wherein the central securing means for axially securing the lamination stack, wherein the lamination stack-(5) and the two end disks-are secured between an axial end stop of the rotor shaft and of the securing means in axial direction with reference to the rotational axis of the rotor.

15. A method for producing a rotor according to claim 1, in which the rotor shaft is provided; the lamination core is connected to the rotor shaft via the shaft receptacle in a positively engaging manner, wherein the lamination core is radially supported at the mating surfaces of the rotor shaft via the supporting surfaces of the shaft receptacle; the magnet units and the insert segments are inserted into the segment receptacles; and the wrap is wound around the lamination stack.
